(19) United States
(12) Patent Application Publication
(10) Pub. No.: US 2023/0214814 A1
(43) Pub. Date: Jul. 6, 2023

(54) MOBILE PAYMENT AND PAYMENT KEYBOARD

(71) Applicant: T-Mobile Innovations LLC, Overland Park, KS (US)

(72) Inventors: Joao Carlos Osorio Gouvea Teixeira de Magalhaes, Shawnee, KS (US); Alisher Rakhimov, Chandler, AZ (US)

(21) Appl. No.: 17/566,115

(22) Filed: Dec. 30, 2021

(51) Int. Cl. G06Q 20/32; G06Q 20/10; G06Q 20/02; G06Q 20/40; H04W 68/00

(52) U.S. Cl. CPC G06Q 20/3223; G06Q 20/102; G06Q 20/02; G06Q 20/4014; H04W 68/005

(57) ABSTRACT

Systems, methods, and computer-readable media are described for facilitating payment between mobile devices through respective mobile service providers. Access to a payment system is provided through a universal mobile device keyboard with a payment key embedded within the universal mobile device keyboard. Selecting the payment key may initiate the payment between a user and a message recipient through their respective mobile device accounts.

### SUMMARY

A high-level overview of various aspects of the present disclosure is provided here to introduce a selection of concepts further described below in the detailed description. This summary is neither intended to identify key features or essential features of the claimed subject matter, nor intended to be used as an aid in isolation to determine the scope of the claimed subject matter.

In brief and at a high level, the present disclosure describes, among other things, systems, methods, and computer-readable media that employ a unique universal default keyboard with payment key which, when selected, initiates a payment from a first user device account to a second user device account. The user device accounts are associated with respective users being subscribed to a telecommunications service provider.

### BRIEF DESCRIPTION OF THE DRAWINGS

Illustrative embodiments of the present disclosure are described in detail below with reference to the attached drawing, wherein:

FIG. 1 depicts an exemplary network environment, in accordance with an embodiment of the present disclosure;

FIG. 2 depicts an exemplary telecommunications environment, in accordance with an aspect of the present disclosure;

FIG. 3A depicts an exemplary messaging application with a universal keyboard, in accordance with an aspect of the disclosure;

FIG. 3B depicts an exemplary messaging application with a universal keyboard, in accordance with another aspect of the disclosure;

FIG. 4 depicts a flowchart of an exemplary method, in accordance with an aspect of the present disclosure; and

FIG. 5 depicts an exemplary computing device suitable for use in implementations of aspects of the present disclosure.

### DETAILED DESCRIPTION

The subject matter of selective embodiments of the present disclosure are described with specificity herein to meet statutory requirements. The detailed description is not intended to define what is regarded as the invention nor intended to limit the scope of the claimed subject matter. The claimed subject matter might be embodied in other ways to include different steps or combinations of steps similar to those described herein, in conjunction with other present or future technologies. Terms recited herein should not be interpreted to imply any particular order among or between various steps described herein unless and except when an order of individual steps is explicitly described.

Throughout the detailed description of the present disclosure, several acronyms and shorthand notations are used to aid the understanding of certain concepts pertaining to an associated system and services. These acronyms and shorthand notations are solely intended for the purpose of providing an easy methodology of communicating the ideas expressed herein and are in no way meant to limit the scope of the present disclosure. The following is a list of these acronyms:

| | |
|---|---|
| AWS | Advanced Wireless Services |
| BRS | Broadband Radio Service |
| BTS | Base Transceiver Station |
| CDMA | Code Division Multiple Access |
| EBS | Educational Broadband Services |
| eNodeB | Evolved Node B |
| EVDO | Evolution-Data Optimized |
| gNodeB | Next Generation Node B |
| GPS | Global Positioning System |
| GSM | Global System for Mobile Communications |
| HRPD | High Rate Packet Data |
| eHRPD | Enhanced High Rate Packet Data |
| LTE | Long Term Evolution |
| LTE-A | Long Term Evolution Advanced |
| PCS | Broadband Personal Communications Service |
| RNC | Radio Network Controller |
| SyncE | Synchronous Ethernet |
| TDM | Time-Division Multiplexing |
| VOIP | Voice Over Internet Protocol |
| WAN | Wide Area Network |
| WCS | Wireless Communications Service |
| WiMAX | Worldwide Interoperability for Microwave Access |

Further, various technical terms are used throughout the detailed description. Definitions of such terms can be found in, for example, Newton's Telecom Dictionary by H. Newton, 31st Edition (2018). These definitions are intended to provide a clear understanding of the ideas disclosed herein but are not intended to limit the scope of the present disclosure. The definitions and the terms should be interpreted broadly and liberally to an extent allowed by the meaning of the words offered in the above-cited reference.

Embodiments of the technology described herein may be implemented as, among other things, a method, a system, or a computer-program product. Accordingly, the embodiments may include a hardware embodiment, or an embodiment combining a software and a hardware. In one embodiment, the present disclosure includes the computer-program product that includes computer-useable instructions embodied on one or more computer-readable media.

The computer-readable media includes volatile and/or nonvolatile media, removable and non-removable media, and contemplates media readable by a database, a switch, and various other network devices. Network switches, routers, and related components are conventional in nature, as are the means of communicating with the same. By way of non-limiting example, the computer-readable media includes computer storage media and/or communications media. The computer storage media, or machine-readable media, includes media implemented in any method or technology for storing information. Examples of stored information includes computer-useable instructions, data structures, program modules, and other data representations. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile discs (DVDs), holographic media or other optical disc storage, magnetic cassettes, magnetic tape, magnetic disc storage, and/or other magnetic storage devices. These memory components may store data momentarily, temporarily, or permanently. The computer storage media does not encompass a transitory signal in embodiments of the present disclosure. The computer storage media does not comprise a propagated data signal.

The communications media typically stores computer-useable instructions, including data structures and program modules, in form of a modulated data signal. The term “modulated data signal” refers to a propagated signal that has one or more of its characteristics set or changed to encode information associated therewith. The communications media includes any information-delivery media. By way of non-limiting example, the communications media includes wired media, such as a wired network or a direct-wired connection; and wireless media, such as acoustic, infrared, radio, microwave, spread-spectrum, and other wireless media technologies. Combinations of the above are included within the scope of the computer-readable media.

At a high level, systems, methods, and the computer-readable media described herein conveys a payment from a first user device account to a second user device account upon request from a unique universal default keyboard and a payment key selection. Currently, mobile device applications utilize a third party payment system or payment account to transfer money between user devices. There is no universal default keyboard with a payment key which links the user device and a corresponding mobile service provider account as a method of transferring money. However, utilizing the universal default keyboard described herein and a unique user device account, there neither is a need for a third party charge account access nor a requirement to access a third party keyboard or the payment key to transfer the money between the user devices. Utilizing the described method and system, the technological problem of unnecessary access of the third party charge account is solved by using a mobile device account as a payment account. For example, by requesting to pay a payee through the payment key on the unique universal default keyboard, the mobile device account is charged rather than requesting an external account, such as a bank account or a credit charge account. With the present disclosure, a need for additional accounts and applications are reduced and thus processing requirements of the user device is reduced.

According to a first aspect of the present disclosure, a method of sending payments is provided. The method comprises receiving a request from a first user device to send a payment from a first user device account to a second user device account, the request to send the payment from the first user device being initiated upon a first user selecting a payment key within a universal mobile device keyboard operating on a messaging application. The method further requests the payment from the first user device account to the second user device account. A payment authorization message is communicated to the second user device account and an authorization from the second user device account to process the payment from the first user device account to the second user device account is received. Upon receipt of the authorization, the payment is sent from the first user device account to the second user device account.

According to a second aspect of the present disclosure, computer-readable media is provided. The computer-readable media includes computer-executable instructions embodied thereon that, when executed, perform a method. The method, executed by the computer-readable media, includes receiving a request from a first user device to send a payment from a first user device account to a second user device account, the request to send the payment from the first user device being initiated upon a first user selecting a payment key within a universal mobile device keyboard operating on a messaging application. The method further requests a payment from the first user device account to the second user device account. A payment authorization message is communicated to the second user device account and an authorization from the second user device account to process the payment from the first user device account to the second user device account is received. Upon receipt of the authorization, the payment is sent from the first user device account to the second user device account.

According to a third aspect of the present disclosure, a system is provided. The system comprises a processor configured to receive a request from a first user device to send a payment from a first user device account to a second user device account, the request to send the payment from the first user device being initiated upon a first user selecting a payment key within a universal mobile device keyboard operating on a messaging application. The processor is further configured to request the payment from the first user device account to the second user device account. A payment authorization message is communicated to the second user device account and an authorization from the second user device account to process the payment from the first user device account to the second user device account is received by the processor. Upon receipt of the authorization, the processor is configured to send the payment from the first user device account to the second user device account.

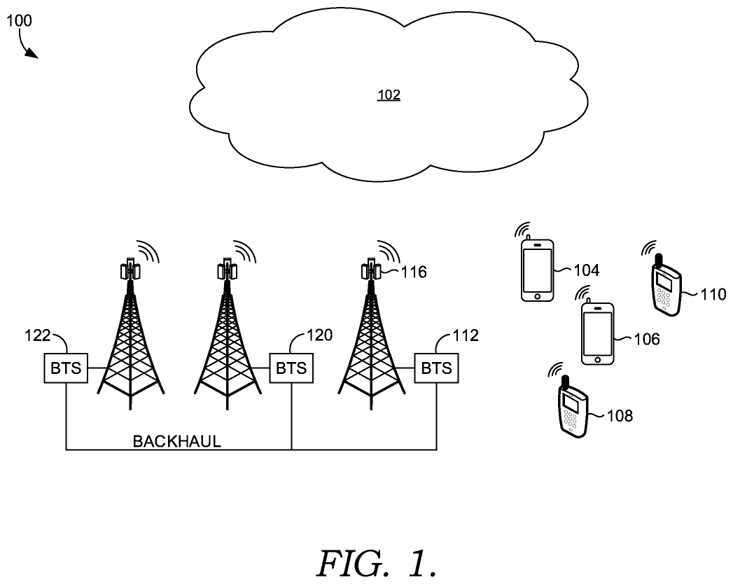

Referring to FIG. 1, an example of a network environment 100 suitable for use in implementing embodiments of the present disclosure is illustrated. The network environment 100 is illustrated as an example of a suitable network environment and is not intended to suggest any limitation to the scope of use or functionality of the present disclosure. Neither should the network environment 100 be interpreted as having any dependency or requirement relating to any one or combination of components illustrated in FIG. 1.

The network environment 100 includes a network 102 that provides service to current user equipment (UE) 104 and 106, and one or more legacy UE 108 and 110. The network 102 may be accessible through a base transceiver station 112 that is connected to a backhaul server (not shown). The base transceiver station 112 and/or a computing device (for example, a local device or a remote device) associated with the base transceiver station 112 may manage or otherwise control operation of components of a cell site, including an antenna array 116. The base transceiver station 112 and/or the computing device associated with the base transceiver station 112 may include one or more processors and computer-readable storage media having computer-executable instructions or computer instruction modules embodied thereon for execution by the one or more processors.

The antenna array 116 may radiate in a particular direction and, thus, may correspond to a particular sector of the cell site. In some embodiments, the antenna array 116 may have a plurality of antenna elements. In one embodiment, the antenna array 116 is configured to have a plurality of elements that in number, arrangement, and/or density, are configured for massive Multiple-in Multiple-out (mMIMO) configuration. In one embodiment, the base transceiver station 112 may include a radio and/or a controller, such as a Massive Multiple-Input Multiple-Output (mMIMO) Unit for controlling a mMIMO configured antenna array, such as the antenna array 116 having the plurality of antenna elements. The base transceiver station 112 may use the controller to monitor one or more of throughput, signal quality metrics (for example, signal-to-interference-plus-noise ratio (SINR)), number of unique users/subscribers, number of unique UE(s), and/or remote location filings that occur at the base transceiver station 112, all of which may be monitored dynamically and/or stored in a data store. The antenna array 116 may also be configured to operate under a lower order number of antenna elements than an antenna array configured to operate under the mMIMO configuration. Such a lower order configuration may be a legacy system, such as an eight branch transmit and eight branch receive (8T8R) antenna structure.

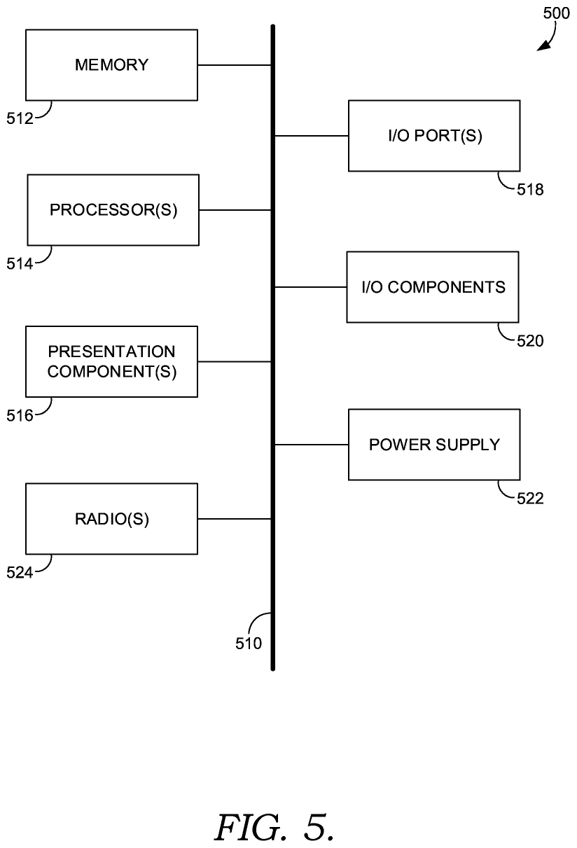

The base transceiver station 112 may use a radio (such as the radio 524 shown in FIG. 5) that is connected to the antenna array 116 by a physical radio-frequency (RF) path, where the radio is used to cause the antenna array 116 to transmit radio-frequency signals using the plurality of antenna elements. The plurality of antenna elements in the antenna array 116 may include portions of antenna elements (not shown). In some embodiments, the plurality of antenna elements of the antenna array 116 may be partitioned such that a first portion of antenna elements may be associated with, dedicated to, correspond to, and/or be configured to operate using a first access technology, and a second portion of antenna elements may be associated with, dedicated to, correspond to, and/or be configured to operate using a second access technology. In one embodiment, the plurality of antenna elements may be partitioned into unequal groups or, alternatively, “split” into equal halves, wherein each group or half operates to provide a coverage area for a distinct access technology when the antenna array 116 operates in a dual technology mode.

In some embodiments, the antenna array 116 is partitioned such that the first portion of antenna elements is associated with a first access technology and the second portion of antenna elements is associated with a second access technology. In some embodiments, when the antenna array 116 is operating in the dual technology mode, each portion of the plurality of antenna elements may operate using only one distinct protocol and/or an access technology relative to the other portions in the antenna array 116. In one example, the first portion of antenna elements may operate using 5G wireless access technology and the second portion of antenna elements may operate using 4G wireless access technology. Additionally, it will be understood that the terms “first” and “second” are used herein for the purpose of clarity in distinguishing portions of antenna elements from one another, but the terms are not used herein to limit the sequence, relevance, number of portions, technological functions, and/or operations of each portion unless specifically and explicitly stated.

As such, the base transceiver station 112 may provide the current UE 104 and 106 and the legacy UE 108 and 110 with access to the network 102. In some embodiments, the first portion of antenna elements may communicate with the current UE 104 and 106 using the 5G wireless access technology, and the second portion of the antenna elements may communicate with the legacy UE 108 and 110 using the 4G wireless access technology. When operating in the dual technology mode, the antenna array 116 may concurrently connect to and communicate with the current UE 104 and 106 and the legacy UE 108 and 110 using, respectively, at least two distinct access technologies.

Accordingly, in one example, when the antenna array 116 is operating in the dual technology mode, the base transceiver station 112 concurrently acts an eNodeB (or “eNB”) and gNodeB (or “gNB”). As such, the base transceiver station 112 may provide service to one or more access technologies to both the current UE 104, 106 and the legacy UE 108, 110. In addition to communicating with the current UE 104 and 106 and the legacy UE 108 and 110, the base transceiver station 112 may also communicate with one or more neighboring base transceiver stations. In some embodiments, the base transceiver station 112 may communicate with neighboring base transceiver station 120 using the first access technology and may communicate with another neighboring base transceiver station 122 using the second access technology. For example, since the base transceiver station 112 may operate concurrently as the eNodeB and the gNodeB using the antenna array 116 that is partitioned and operating in the dual technology mode, the base transceiver station 112 may communicate with other base transceiver stations, such as the neighboring base transceiver stations 120 and 122. For example, the base transceiver station 112 communication may include legacy base transceiver stations that cannot use current access technologies (for example 5G) or current base transceiver stations that lack backward compatibility with prior access technologies (for example 4G). In some embodiments, the base transceiver station 112 may bi-directionally exchange information with the neighboring base transceiver stations 120 and 122 through an X2 interface or X2 link. Information regarding signal quality, RF conditions, one or more RLFs, and SINR levels at each of the neighboring base transceiver stations 120 and 122, and/or as reported from the current or legacy UE to the neighboring base transceiver stations 120 and 122, may be communicated to the base transceiver station 112 via the X2 link. Additionally, or alternatively, information regarding the signal quality, the RLFs, and the SINR levels at each of the neighboring base transceiver stations 120 and 122 may be communicated to the base transceiver station 112 over a backhaul.

As mentioned, the base transceiver station 112 may include the radio and/or the controller, such as a memory management unit (MMU), that enables the base transceiver station 112 to adjust or modify the operations and transmissions of the plurality of antenna elements in the antenna array 116. In some embodiments, operations, configurations, and/or settings of each antenna element may be individually controlled and adjusted by the base transceiver station 112 using the controller. In some embodiments, the operations, configurations, and/or settings of the first portion of antenna elements may be controlled and adjusted as a group by the base transceiver station 112 using the controller, such as the MMU, independent of the second portion of antenna elements. In a similar fashion, the operations, the configurations, and/or the settings of the second portion of antenna elements may be controlled and adjusted as a group by the base transceiver station 112 using the controller, independent of the first portion of antenna elements. Accordingly, the base transceiver station 112 may use the controller to independently adjust different groups or portions of the antenna elements within one antenna array, such as the antenna array 116.

In some embodiments, the operations, the configurations, and/or the settings of each individual antenna element may be adjusted and customized. For example, the base transceiver station 112 instructs a portion of the antenna elements to transmit one or more synchronization signals using a periodicity. In another example, the portion of the antenna elements may transmit a plurality of synchronization signals using the periodicity, as instructed by the base transceiver station 112. In some embodiments, the synchronization signals may be specific to and/or configured for the first access technology.

Accordingly, the base transceiver station 112 may use the controller to independently adjust different individual antenna elements, any number of groupings and/or subset(s) of each portion of the antenna elements, and/or portions of the antenna elements within one antenna array, such as the antenna array 116. In some embodiments, the base transceiver station 112 may use the controller to measure and monitor one or more of throughput, signal quality metrics (for example, SINR), number of unique users/subscribers, number of unique UE, and/or RLFs.

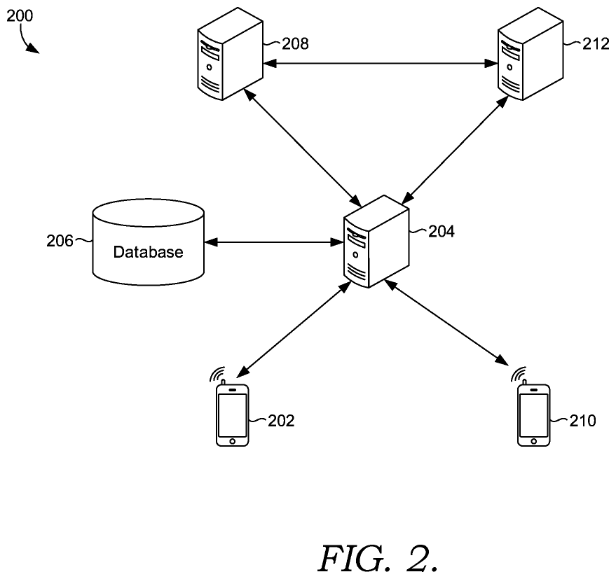

Referring to FIG. 2, an exemplary network environment 200 is illustrated in which implementations of the present disclosure may be employed. The network environment 200 is one example of a suitable network environment and is not intended to suggest any limitation as to the scope of use or functionality of the present disclosure. Neither should the network environment 200 be interpreted as having any dependency or requirement relating to any one or combination of components illustrated.

The network environment 200 represents a high level and simplified view of relevant portions of a modern wireless telecommunication network. At a high level, the network environment 200 may generally include one or more UEs, such as a first UE 202 and a second UE 210, a network 204, a database 206, one or more user device accounts, such as a first user device account 208 and a second user device account 212, though in some implementations, it may not be necessary for certain features to be present. The network environment 200 is generally configured for wirelessly connecting the first UE 202 with other UEs and with other telecommunication networks, such as a publicly-switched telecommunication network (PSTN), or data or services that may be accessible on one or more application servers or other functions, nodes, or servers not illustrated in FIG. 2, so as to not obscure the focus of the present disclosure. As illustrated generally, the first UE 202 may be implemented as, for example, a tablet, a phone, or a wearable device, or any other device discussed with respect to FIG. 1. In some aspects, the first UE 202 may specifically not be a conventional telecommunications device (for example, device that is capable of placing and receiving voice calls) but may instead take a form of a device that only utilizes wireless network resources in order to transmit or receive data. Such devices may include IoT devices (for example, smart appliances, thermostats, locks, smart speakers, lighting devices, smart receptacles, and the like).

The first UE 202 is generally configured to transmit and receive one or more signals between a base transceiver station (such as the base transceiver station 112 in FIG. 1) associated with the network 204 and the first UE 202. Communication protocols associated with the network 204 are configured to receive one or more signals from the first UE 202, and the one or more signals may be implemented as uplink signals. In response to receiving certain requests from the first UE 202, the communication protocol may communicate with the network 204. For example, in order for the first UE 202 to connect to a desired network service (for example, PSTN call, voice over LTE (VoLTE) call, voice over new radio (VoNR), data, or the like), the first UE 202 may communicate an attach request to the communication protocol, which, in response, may communicate a registration request to the network 204. The communication protocol may take the form of a home network (for example, a protocol belonging to or affiliated with a carrier associated with the first UE 202) or a visiting/roaming network (for example, a protocol belonging to or operated by an entity other than the carrier associated with the first UE 202, but which, in certain conditions, may provide extended wireless access to the first UE 202 beyond a reach of the home network).

The network 204 may be a part of a telecommunication network that connects subscribers to their service provider. In some aspects, the service provider may be a telecommunications service provider, an internet service provider, or any other similar service provider that provides at least one of voice telecommunications and/or data services to the first UE 202 and any other UEs. For example, the network 204 may be associated with a telecommunications provider that provides services (for example, LTE) to the first UE 202. Additionally, or alternatively, the network 204 may provide voice, SMS, and/or data services to user devices or corresponding users that are registered or subscribed to utilize the services provided by the telecommunications provider. The network 204 may include any communication network providing voice, SMS, and/or data service(s), using any one or more communication protocols, such as a 1×circuit voice, a 3G network (for example, CDMA, CDMA2000, WCDMA, GSM, UMTS), a 4G network (WiMAX, LTE, HSDPA), or a 5G network. The network 204 may also be, in whole or in part, or have characteristics of, a self-optimizing network.

The network 204 includes one or more systems that are enabled for routing information and/or enabling communication between the first UE 202 and the second UE 210. Additionally, the network 204 includes one or more systems that are enabled for communication between the network 204, the first UE 202 and the first user device account 208. In one example, the first user device account 208 is directly associated with the network 204. For example, the network 204 enables the first UE 202 to communicate by way of the network 204 because the first UE 202 is subscribed to the network 204 through the first user device account 208. The network 204 is enabled to communicate with the first user device account 208 through one or more systems and/or the database 206. The first user device account 208 enables the first UE 202 to communicate through the network 204. In other words, the first user device account 208 identifies the first UE 202 as a subscriber to the network 204. For example, first user device account 208 may be a subscriber account with a particular telecommunications company. The network 204 may be operated as a part of that telecommunications network or may be operated by another telecommunications network as described above.

The first user device account 208 enables the first UE 202 to communicate by way of the network 204. The first user device account 208 enables the network 204 to authenticate the first UE 202 through a variety of means and authorizes the first UE 202 to use the network 204. The first user device account 208 stores, in the database 206, identifying information, such as username, user ID, account number, the first UE 202 identifiers, the first UE 202 make and model, and other personal information, such as an available funds balance. In one aspect, the first user device account 208 acts as a charge account for the first UE 202. For example, the first UE 202 may authorize charging the first user device account 208, which has an available funds balance, and to transfer funds to the second user device account 212. For example, the first UE 202 may request a funds transfer from the first user device account 208 to the second user device account 212. The network 204 may then authorize a withdrawal of funds from the first user device account 208 and transfer those funds to the second user device account 212. In one aspect, the first user device account 208 acts as a bank account being supported by the telecommunications network or directly backed/authorized by a banking institution. In another aspect, the first user device account 208 acts as an escrow account.

Relevant to this disclosure, the first UE 202 must first initiate a request to transfer funds from the first user device account 208 to the second user device account 212. This may be done by way of a unique user device specific keyboard (alternatively referred to as “the universal mobile device keyboard”) as described herein. For example, the user may select a payment key within the universal mobile device keyboard while using a SMS messaging application and communicating with second user device 210 through the network 204. Upon selecting the payment key, the user may input a desired amount to be sent to the second user device account 212 from the first user device account 208. The network 204 subsequently requests the requested funds to be debited from the first user device account 208. A message may be sent to the second UE 210 from the network 204 requesting authorization of the payment from the first user device account 208 to the second user device account 212. This message may be in the form of a push notification with the user of the second UE 210 being able to authorize the payment.

Once authorized, the payment is transferred from the first user device account 208 to the second user device account 212. The second user device account 212 may act as a bank account, similar to the first user device account 208 and may be directly linked to a banking institution account or having the telecommunication network acting as the banking institution. For example, if the second UE 210 is a subscriber to a same telecommunication network as the first UE 202, the second user device account 212 may act as a bank or charge account directly linked to the user's subscription account. However, if the second UE 210 is not subscribed to the same telecommunication network, the second user device account 212 may act as the escrow account, holding the transferred funds until withdrawal is requested by the second UE 210 or a second user. For example, if the second user is not a subscriber to the same telecommunications network, the network 204 may create the escrow account or the second user device account 212 for holding the transferred funds. The network 204 will subsequently provide a secure way for the user of the second UE 210 to withdraw the funds from the second user device account 212. The network 204 may provide the secure way by way of a link to input a charge account information to transfer the funds from the second user device account 212 to an alternative charge account.

The authorization of the payment and a notification of status of the payment is sent to both the first UE 202 and the second UE 210 by way of the network 204. For example, the network 204 will request to charge the first user device account 208 and will subsequently store a record of that action in the database 206. A notification may be sent by the network 204 to the second UE 210 indicating that the payment has been requested by the first user device account 208. Additionally, upon completion of transfer of the payment, the network 204 may store a record of the transfer in the database 206 and provide a notification to the first UE 202 and the second UE 210. The network 204 may store a record of all actions taken and requests made, in the database 206. The database 206 may store in a ledger, the account balance of both the first user device account 208 and the second user device account 212.

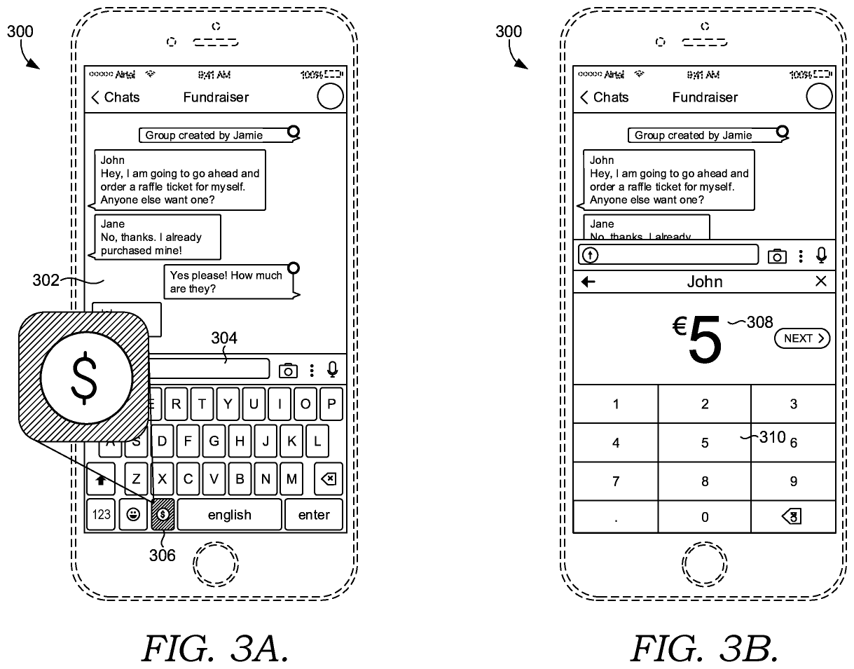

Referring to FIG. 3A, the universal mobile device keyboard is shown according to one aspect of the present disclosure. A cellular device application 300 may be said to exist on a user device, such as the first UE 202, as described above and may exist with one or more components discussed in greater detail herein and is not meant to exhaustively show every interaction that would be necessary to practice the present disclosure, so as to not obscure the inventive concept but is instead meant to illustrate one or more potential interactions between components. The cellular device application 300 may be said to include an SMS messaging application (such as a text messaging application included with the first UE 202) or a downloaded application such as a social media application, a universal keyboard 304 including a number of input keys, and a payment key 306. The universal keyboard 304 is designed to be universally used within each SMS application installed on the first UE 202. For example, the first UE 202 may have a social media application installed and once the universal keyboard 304 is opened within the social media application, the universal keyboard 304 initiates. Within the universal keyboard 304 exists a number of selectable buttons which perform various functions such as typing a message to a second user. The payment key 306 initiates a request for the payment between the first UE 202 and another UE. For example, the user may be messaging the second user via the text messaging application installed on the first UE 202. When the user selects the payment key 306, a request to send the payment to the second user is initiated. The selection of the payment key 306 is linked to a request to charge the first user device account 208 as described above.

In some embodiments, the universal keyboard 304 may be a default keyboard on a UE, such as the first UE 202. For example, a network provider may install the universal keyboard 304 on a device prior to a user's first time using the device. The first UE 202 may have the universal keyboard 304 as the default keyboard for any messaging or the SMS messaging application installed on the first UE 202. For example, if the user installs the social media application on the first UE 202, the default keyboard would be the universal keyboard 304 with the payment key 306. The payment key 306 automatically sends the request to the user device account associated with the user equipment and the user as described above.

Continuing with FIG. 3B, when the user selects the payment key 306 as shown in FIG. 3A, a number pad 310 appears with an indication of a payee and a payment amount 308. The user may input the payment amount 308, via the number pad 310, wished to be sent to the payee. In the text box, the payment amount 308 desired to be sent may appear and the payee or a recipient name may appear above. By proceeding with the payment, the user is indicating that they wish to initiate the payment to the payee. For example, the network 204 may then receive a request for the payment to be sent to the payee. The payment amount 308 is then deducted from the payer's account or the first user device account 208. A push notification or request for authorization may then be sent to the payee. The payee may authorize the payment towards the user device account associated with the payee. The payee may also be presented with an option to input charge account credentials to receive payment directly to a bank account. The payee may authorize the payment to go into the escrow account associated with the user for later withdrawal.

Once the payee authorizes the payment and a manner in which it is wished to be received, the payment is then transferred to the account of the payee. For example, if the payee authorized the payment to go directly to the account associated with the user device account of the payee, the payment will then be directly transferred from the user device account of the payer to the user device account of the payee. Both accounts are mobile device service provider accounts. If the payee authorized the payment to go into the escrow account, the payment is transferred to the escrow account of the payee. The payee may later access the escrow account and transfer available funds to a separate bank account. The payee may also deposit the funds into the escrow account to provide the payment through the above service, or to the payer/first user.

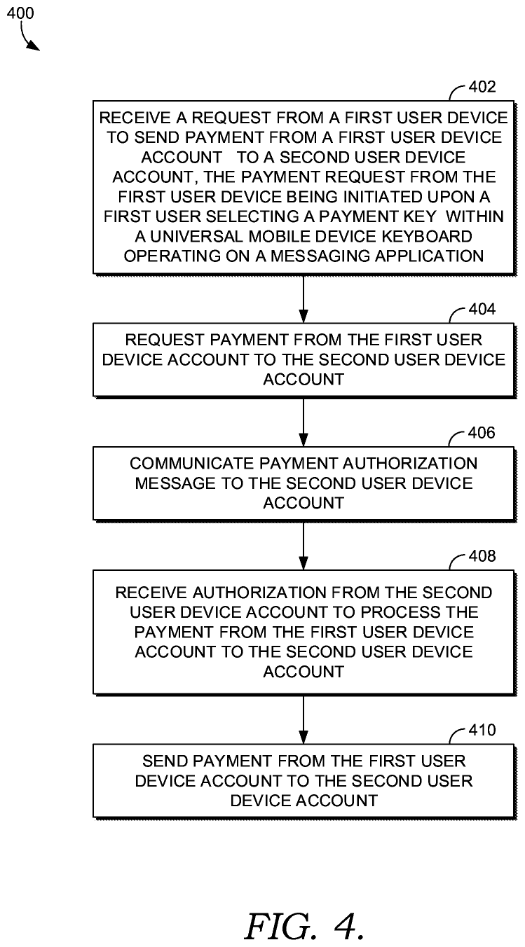

Referring to FIG. 4, a flowchart of an exemplary method 400 is illustrated for providing the payment from the user device account (such as the first user device account 208 and the second user device account 212) by means of the universal keyboard 304. The method 400 is described in conjunction with FIG. 1 to FIG. 3B. Initially at block 402, the method 400 includes receiving a request from the first user device (such as the first UE 202) to send the payment from the first user device account 208 to the second user device account 212. The payment request from the first UE 202 is initiated by the first user selecting the payment key 306 within the universal mobile device keyboard (such as the universal keyboard 304) operating on a messaging application. The universal keyboard 304 is the default keyboard for any application within the UE (such as the first UE 202 or the second UE 210). At block 404, the method 400 includes requesting payment from the first user device account 208 to the second user device account 212 via the network (such as the network 204) or a server. At block 406, a communication is sent to request a payment authorization to the second user device account. At block 408, the second user device (such as the second UE 210) sends an authorization to process the payment from the first user device account 208 to the second user device account 212 and at block 410, the payment is sent from the first user device account 208 to the second user device account 212.

Referring now to FIG. 5, an exemplary computing environment suitable for use in implementations of the present disclosure, is illustrated. In particular, the computer environment is shown and designated generally as a computing device 500. The computing device 500 is but one example of a suitable computing environment and is not intended to suggest any limitation as to the scope of use or functionality described in the present disclosure. Neither should the computing device 500 be interpreted as having any dependency or requirement relating to any one or combination of components illustrated in FIG. 5.

The implementations of the present disclosure may be described in the general context of a computer code or machine-useable instructions, including computer-executable instructions, such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, and the like. Implementations of the present disclosure may also be practiced in distributed computing environments where tasks are performed by remote-processing devices that are linked through a communications network.

With continued reference to FIG. 5, the computing device 500 includes a bus 510 that directly or indirectly couples the following devices: a memory 512, one or more processor(s) 514, one or more presentation component(s) 516, input/output (I/O) port(s) 518, I/O components 520, a power supply 522 and radio(s) 524. The bus 510 may include one or more busses (such as an address bus, a data bus, or a combination thereof). Although the devices in FIG. 5 are shown with lines for the sake of clarity, in reality, delineating various components is not so clear and, metaphorically, the lines would more accurately be grey and fuzzy. For example, one may consider a presentation component, such as a display device to be one of the I/O components 520. Also, processors, such as the one or more processors 514, have the memory 512. The present disclosure herein recognizes that such is the nature of the art and reiterates that FIG. 5 is merely illustrative of an exemplary computing environment that may be used in connection with one or more implementations of the present disclosure. Distinction is not made between such categories as “a workstation,” “a server,” “a laptop,” “a handheld device,” etc., as all are contemplated within the scope of FIG. 5 and are referred to as “a computer” or “a computing device.”

The computing device 500 typically includes a variety of computer-readable media. The computer-readable media may be any available media that may be accessed by the computing device 500 and includes both volatile and nonvolatile media, removable and non-removable media. By way of a non-limiting example, the computer-readable media may include computer storage media and communication media. The computer storage media includes both volatile and nonvolatile, removable, and non-removable media implemented in any method or technology for storage of information, such as computer-readable instructions, data structures, program modules, or other data.

The memory 512 includes computer-storage media in the form of volatile and/or nonvolatile memory. The memory 512 may be removable, non-removable, or a combination thereof. In some examples, the memory 512 includes a solid-state memory, hard drives, optical-disc drives, etc. The computing device 500 includes the one or more processors 522 that read data from various entities, such as the bus 510, the memory 512, or the I/O components 520. The one or more presentation component(s) 516 presents data indications to a person or other device. In an example, the one or more presentation component(s) 516 include a display device, a speaker, a printing component, a vibrating component, etc. The I/O port(s) 518 allow the computing device 500 to be logically coupled to other devices, including the I/O components 520, some of which may be built in the computing device 500. The I/O components 520 include a microphone, a joystick, a game pad, a satellite dish, a scanner, a printer, a wireless device, etc.

The radio(s) 524 of the computing device 500 represents a radio that facilitates communication with a wireless telecommunications network. In an example, wireless telecommunications technologies include, but are not limited to, code-division multiple access (CDMA), general packet radio service (GPRS), time-division multiple access (TDMA), global system for mobile communication (GSM), and the like. The radio(s) 524 may additionally or alternatively facilitate other types of wireless communications including wireless fidelity (Wi-Fi), worldwide interoperability for microwave access (WiMAX), long-term evolution (LTE), or other voice over internet protocol (VoIP) communications. As may be appreciated, in various embodiments, the radio(s) 524 may be configured to support multiple technologies and/or multiple radios may be utilized to support multiple technologies. The wireless telecommunications network may include an array of devices, which are not shown so as to not obscure more relevant aspects of the present disclosure. Components, such as the base transceiver station 112, a communications tower, or access points (as well as other components), may provide wireless connectivity in some embodiments.

Many different arrangements of the various components depicted, as well as components not shown, are possible without departing from the scope of the claims below. Embodiments of the present disclosure have been described with an intent to be illustrative rather than be restrictive. Alternative embodiments will become apparent to readers of the present disclosure. Alternative means of implementing the aforementioned aspects may be completed without departing from the scope of the claims below. Certain features and sub-combinations of aspects of the present disclosure are of utility and may be employed without reference to other features and sub-combinations and are contemplated within the scope of the claims.

1. One or more computer-readable media having computer-executable instructions embodied thereon that, when executed, perform a method of sending payments using a payment key on a universal mobile device keyboard, the method comprising:
receiving, by a telecommunications network, a request from a first user device to send a payment from a first user device account to a second user device account, the request to send the payment from the first user device being initiated upon a first user selecting the payment key within the universal mobile device keyboard operating on a messaging application, wherein the first user device is operating using a mobile device account associated with the telecommunications network;
requesting, by the telecommunications network, the payment from the first user device account to the second user device account, wherein the first user device account and the second user device account are associated with a telecommunications network provider;
communicating, by the telecommunications network, a payment authorization message to the second user device account;
receiving, by the telecommunications network, an authorization from the second user device account to process the payment from the first user device account to the second user device account; and
sending the payment, by the telecommunications network, from the first user device account to the second user device account.

2. The one or more computer-readable media of claim 1, wherein the first user device account is a charge account within a mobile device service provider account.

3. The one or more computer-readable media of claim 2, wherein the payment key is linked to the first user device account.

4. The one or more computer-readable media of claim 1, wherein the universal mobile device keyboard is a default keyboard for all applications operating on the first user device.

5. The one or more computer-readable media of claim 1, wherein by selecting the payment key within the universal mobile device keyboard operating on the messaging application, the second user device account is automatically determined based on a message recipient selection.

6. The one or more computer-readable media of claim 1, wherein the payment authorization is communicated through a push notification.

7. The one or more computer-readable media of claim 1, wherein the payment authorization authorizes the payment to the second user device account.

8. The one or more computer-readable media of claim 7, wherein the second user device account is a charge account within a second user mobile device service provider account.

9. The one or more computer-readable media of claim 1, wherein the payment authorization authorizes the payment to a second mobile device escrow account.

10. A method of sending payments using a payment key on a universal mobile device keyboard, the method comprising:
receiving, by a telecommunications network, a request from a first user device to send a payment from a first user device account to a second user device account, the request to send the payment from the first user device being initiated upon a first user selecting the payment key within the universal mobile device keyboard operating on a messaging application, wherein the first user device is operating using a mobile device account associated with the telecommunications network;
requesting, by the telecommunications network, the payment from the first user device account to the second user device account, wherein the first user device account and the second user device account are associated with a telecommunications network provider;
communicating, by the telecommunications network, a payment authorization message to the second user device account;
receiving, by the telecommunications network, an authorization from the second user device account to process the payment from the first user device account to the second user device account; and
sending the payment, by the telecommunications network, from the first user device account to the second user device account.

11. The method of claim 10, wherein the universal mobile device keyboard is a default keyboard for all applications operating on the first user device.

12. The method of claim 10, wherein by selecting the payment key within the universal mobile device keyboard operating on the messaging application, the second user device account is automatically determined based on a message recipient selection.

13. The method of claim 10, wherein the payment authorization is communicated through a push notification.

14. The method of claim 10, wherein the payment authorization authorizes the payment to the second user device account.

15. The method of claim 10, wherein the second user device account is a charge account within a second user mobile device service provider account.

16. The method of claim 10, wherein the payment authorization authorizes the payment to a second mobile device escrow account.

17. A system for sending payments using a payment key on a universal mobile device keyboard, the system comprising a processor configured to:
receive a request, by a telecommunications network, from a first user device to send a payment from a first user device account to a second user device account, the request to send the payment from the first user device being initiated upon a first user selecting a payment key within a universal mobile device keyboard operating on a messaging application, wherein the first user device is operating using a mobile device account associated with the telecommunications network;
request the payment, by the telecommunications network from the first user device account to the second user device account, wherein the first user device account and the second user device account are associated with a telecommunications network provider;
push a payment authorization message, by the telecommunications network, to the second user device account;
receive, by the telecommunications network, an authorization from the second user device account to process the payment from the first user device account to the second user device account; and
send, by the telecommunications network, the payment from the first user device account to the second user device account.

18. The system of claim 17, wherein the universal mobile device keyboard is a default keyboard for all applications operating on the first user device.

19. The system of claim 17, wherein by selecting the payment key within the universal mobile device keyboard operating on the messaging application, the second user device account is automatically determined based on a message recipient selection.

20. The system of claim 17, wherein the payment authorization is communicated through a push notification.
